(19) United States
(12) Patent Application Publication
(10) Pub. No.: US 2003/0065632 A1
(43) Pub. Date: Apr. 3, 2003

(54) Scalable, parallelizable, fuzzy logic, boolean algebra, and multiplicative neural network based classifier, datamining, association rule finder and visualization software tool

(76) Inventor: Haci-Murat Hubey, Fort Lee, NJ (US)

Correspondence Address: H. M. HUBEY, APT. 14R, 2100 LINWOOD AVE, FORT LEE, NJ, 07024, US

(21) Appl. No.: 10/158,526

(22) Filed: May 30, 2002

Related U.S. Application Data
(60) Provisional application No. 60/294,314, filed on May 30, 2001.

(51) Int. Cl. G06F 15/18

(52) U.S. Cl. 706/15

(57) ABSTRACT

A method is disclosed for for computing clusters, relationships amongst clusters, and association rules from data at various levels of significance. First the clusters are found via a dual-approximation method followed by Boolean minimization. Then a customized multiplicative neural network which uses a special kind of fuzzy logic is constructed from the association rules. This particular fuzzy-logic shows how make arithmetic equal to fuzzy-logic. Other types of fuzzy logics appropriate for this datamining tool are described. This particular method of clustering is multiplicative, resembling “dimensional analysis” of physics and engineering in contrast to the linear methods such as principal component analysis (PCA). The complete set of association rules is constructed from the data automatically. Then 2-dimensional and 3-dimensional visualization and visual-datamining tools are constructed.

### CROSS-REFERENCE TO RELATED APPLICATION

This application claims the benefit of U.S. PRovisional Application No. 60/294,314 filed on May 30, 2001.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISC APPENDIX

None.

### BACKGROUND OF THE INVENTION

1. Field of the Invention

The present invention relates to the field of “data mining” or knowledge discovery in computer databases and data warehouses. More particularly, it is concerned with ordering and classifying data in large multidimensional data sets, and uncovering correlations among the data sets.

2. Description of the Related Art

Data mining seeks to uncover patterns hidden within large multidimensional data sets. It involves a set of related tasks which include: identifying concentrations or clusters of data, uncovering association rules within the data, and applying automated methods that use already discovered knowledge to efficiently classify data. These tasks may be facilitated by a method of visualizing multidimensional data in two dimensions.

Cluster analysis is a process that attempts to group together data objects (input vectors) that have high similarity in comparison with one another but are dissimilar to objects in other clusters. Current forms of cluster analysis include partitioning methods, hierarchical methods, density methods, and grid-based methods. Partitioning methods employ a distance/dissimilarity metric to determine relative distances among clusters. Hierarchical methods decompose data using a top down approach that begins with one cluster and successively splits it into smaller clusters until a termination condition is satisfied. (Bottom up techniques that successively merge data into clusters are also classified as hierarchical). The main disadvantage of hierarchical methods is that they cannot backtrack to correct erroneous split or merge decisions. Additionally, both partitioning and hierarchical methods have trouble identifying irregularly shaped clusters. Density based methods attempt to address this problem by continuing to grow a cluster until the density in the area of the cluster exceeds some threshold. Like the previously described methods, however, density methods also have problems with error reduction. Finally, grid based methods quantize the object space into a finite number of cells that form a grid structure in which clusters may be identified.

Association Rules are descriptions of relationships among data objects. These are most simply defined in the form: “X implies Y.” Thus, an association rule uncovers combinations of data objects that frequently occur together. For example, a grocery store chain has found that men who bought beer were also likely to buy diapers. This example demonstrates a simple two-dimensional association rule. When the input vectors are multidimensional, however, association rules become more complex and may not be of particular interest. The present invention includes a method for deriving simplified association rules in multidimensional space. Additionally, it allows for further refinement of cluster identification and association rule mining by incorporating an Artificial Neural Network (ANN, defined below) to classify data (and to estimate).

Classification is the process of finding a set of functions that describe and distinguish data classes for the purpose of using the functions to determine a class of objects whose class label is unknown. Thus, it is simply a form cluster. The derived functions are based upon analysis of a set of training data (objects with a known class label). Data mining applications commonly use ANNs to determine weighted connections among the input vectors. An ANN is a collection of neuron-like processing units with weighted connections between units. It consists of an input layer, one or more hidden layers, and an output layer. The problem with using ANNs is that it is difficult to determine how many processors should be in the hidden layer and the output layer. Prior art has depended on heuristic methods in determining the rank and dimension of the output vector. The present invention improves upon the prior art by incorporating a three layered multiplicative ANN (hereinafter “MANN”) in which the number of hidden/middle layer neurons are are determined as a part of the datamining method.

Finally, data visualization can be an effective means of pattern discovery. Although the eye is good at observing patterns in low dimensional data, it is inherently limited to three dimensional space. The present invention includes a method that employs a unique data structure called a KH-map to transform multidimensional data into a two dimensional representation.

### DESCRIPTION OF THE RELATED ART

Datamining is based on clustering hence a good clustering method is very important. Requirements for an ideal clustering procedure include:

(i) Scalability:: the procedure should be able to handle large number of objects, or should have a complexity of O(n), O(logn), O(nlogn)

(ii) Ability to deal with different types of attributes:: the method should be able to handle various types such as nominal (binary, or categorical), ordinal, interval, and ratio scale data.

(iii) Discovery of clusters with arbitrary shape:: the procedure should be able to cluster shapes other than spherical/spheroidal which is what most distance metrics such as the Euclidean or Manhattan metrics produce.

(iv) Minimal requirements for domain knowledge to determine input parameters:: it should not require the user to input various magic parameters

(v) Ability to deal with noisy data:: it should be able to deal with outliers, missing data, or erroneous data. Certain techniques such as artificial neural networks seem better than others.

(vi) Insensitivity to the order of input records:: the same set of data presented in different orderings should not produce a different set of clusters.

(vii) High dimensionality:: human eyes are good at clustering low-dimensional (2D or 3D) data but clustering procedures should work on very high dimensional data

(viii) Constraint-based clustering:: the procedure should be able to handle various constraints

(ix) Interpretability and usability:: the results should be usable, comprehensible and interpretable. For practical purposes this means that the results such as association rules should be given in terms of logic, Boolean algebra, probability theory or fuzzy logic.

The memory-based clustering procedures typically operate on one of two data structures: data matrix or dissimilarity matrix. The data matrix is an object-by-variable structure whereas the dissimilarity matrix is an object-by-object structure. The data matrix represents n objects with m attributes (measurements). Every object is a vector of attributes, and the attributes may be on various scales such as (i) nominal, (ii) ordinal, (iii) interval/difference (relative) or (iv) ratio (absolute). The d(j, k) in the dissimilarity matrix is the difference (or perceptual distance) between objects j and k. Therefore d(j, k) is zero if the objects are identical and small if they are similar. These common structures are shown below in Eq. (1).

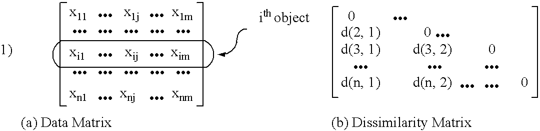

The major clustering methods can be categorized as [Han & Kamber, Datamining, Morgan-Kaufman, 2001]:

(i) Partitioning Methods:: The procedure constructs k partitions of n objects (vectors or inputs) where each partition is a cluster with k≦n. Each cluster must contain at least one object and each object must belong to exactly one cluster. A distance/dissimilarity metric is used to cluster data that are ‘close’ to one another. The classical partitioning methods are the k-means and k-medoids. The k-medoids method is an attempt to diminish the sensitivity of the procedure to outliers. For large data sets these procedures are typically used with probability based sampling, such as in CLARA (Clustering Large Applications). [Han & Kamber, Datamining, Morgan-Kaufman, 2001].

(ii) Hierarchical Methods:: These methods create a hierarchical decomposition of data (i.e. a tree of clusters) using either an agglomerative (bottom-up) or divisive (top-down) approach. The former starts by assuming that each object represents a cluster and successively merges those close to one another until all the groups are merged into one, the topmost level of the hierarchy, (as done in AGNES (Agglomerative Nesting)) whereas the latter starts by assuming all the objects are in a single cluster and proceed split up the cluster into smaller clusters until some termination condition is satisfied (as in DIANA (Divisive Analysis)). The basic disadvantage of these methods is that once a split or merge is done it cannot be undone thus they cannot correct erroneous decisions and perform adjustments to the merge or split. Attempts to improve the quality of the clustering is based on: (1) more careful analysis at hierarchical partitional linkages (as done by CURE or Chameleon) or (2) by first using an agglomerative procedure and then refining it by using iterative relocation (as done in BIRCH). [Han & Kamber, Datamining, Morgan-Kaufman, 2001].

(iii) Density-based Methods:: Most partitioning methods are similarity-based (i.e. distance-based). Minimizing distances in high dimensions results in clusters that are hyper-spheres and thus these methods cannot find clusters of arbitrary shapes. The famous inability of the perceptron to recognize an XOR can be considered to be an especially simple case of this problem [Hecht-Nielsen 1990:18]. The density-based methods are attempts to overcome these disadvantages by continuing to grow a given cluster as long as the density in the neighborhood exceeds some threshold. DBSCAN (Density-based Spatial Clustering of Applications with Noise) is a procedure that defines a cluster as a maximal set of density-connected points. A cluster analysis method called OPTICS tries to overcome these problems by creating a tentative set of clusters for automatic and interactive cluster analysis. CLIQUE and WaveCluster do density-based clustering among others. DENCLUE works by using density functions (such as probability density functions) as attractors of objects. DENCLUE generalizes other clustering methods such as the partition-based, and hierarchical methods. It also allows a compact mathematical description of arbitrarily shaped clusters in high dimensional spaces. [Han & Kamber, Datamining, Morgan-Kaufman, 2001].

Grid-based Methods:: These methods quantize the object space into a finite number of cells that form a grid structure and this grid is where the clustering is done. The method outlined here, in the latter stage, may be thought of as a very special kind of a grid-based method. It takes advantage of the fast processing time associated with grid-based methods. In addition, the quantization may be done in a way to create equal relative quantization errors. STING is a grid-based method whereas CLIQUE and WaveCluster also do grid-based clustering. [Han & Kamber, Data-mining, Morgan-Kaufman, 2001].

Model-based Methods:: These methods are more appropriate for problems in which a great deal of domain-knowledge exists, for example, problems in engineering which is physics-based.

### SUMMARY OF THE INVENTION

The invention is applicable in general to a wide variety of problems because it lends itself to the use of crisp logic, fuzzy logic, probability theory in multidimensional phenomena, which are serial/sequential (time series, DNA sequences), or data without regard to the order in which the events occur.

1) The method normalizes the input vectors to {0, 1}ⁿ. This is the first approximation method. The effects of the loss of information is counteracted by the second approximation method.

2) It then creates a KH-map of the normalized input vectors. Then after thresholding it applies a simplification/minimization method to produce clustering and for which the Quine-McClusky method or an equivalent method is used. The simplification stage is the second approximation method which works to undo some of the coarse-grained clustering done in the first stage. Here, again, because the data represents uncertainty and because the phenomena can be understood at multiple scales, we can use either fuzzy logic or probabilistic interpretations of the results of this stage. The first and second approximation methods work to create clusters. FIG. (1) and FIG. (2) show the flow of data and also the general logic and option diagram of the invention. FIG. (2) shows the three basic aggregates of the dataminer; (1) the Minimizer/clusterer/association-rule finder, (2) the multiplicative neural network classifier and estimator, and (3) the KH-map visual datamining and visualization tool, the toroidal visualization, the Locally-Euclidean-grid creater and visualizer, and the hypercube visualization tool. The method works to find the kinds of clusters for example as those in FIG. (3A), and nonlinearly separable clusters as in FIG. (3B). FIG. (13B) shows a cluster at a high-degree of resolution. FIG. (14A) shows a cluster as it is visualized on a hypercube of dimension-4 (a 4-cube).

3a) The method further refines the result either by training it as a neural network to use it as a classifier or a fuzzy decoder. Examples of these neural networks are shown in FIG. (9), FIG. (10B,C,D), FIG. (11) and FIG. (12). After the 2nd stage is over we have in possession a [fuzzy] Boolean expression for the input vectors however the approximation is still coarse. This stage fine tunes the result. This stage uses a special kind of fuzzy logic that can be used for data in z,900 ⁿ directly without normalized data, and which produces clusters which are immediately interpretable as association rules using [fuzzy] logical expressions using conjunctions and disjunctions. These clusters may also be treated as results of generalized dimensional analysis. (Olson, R (1973) Essentials of Engineering Fluid Mechanics, Intext Educational Publishers, NY, and White, F. (1979) Fluid Mechanics, McGraw-Hill, New York.)

3b) In this stage, the method uses the metric defined on the KH-map, to perform permutations of the components of the input vectors [which corresponds to automorphisms of the underlying hypercube an example of which is given in FIG. (4)] so that the distances along the KH-map (or the torus surface) correspond to the natural distances between the clusters of the data. If two events are very highly correlated, then they are ‘near’ each other in some way. This stage of the method permutes the KH-map (which is the same as the automorphisms of the underlying hypercube, and the permutation of the components of the input vectors) so that closely related events are close on the KH-map. In other words, yet another larger-scale clustering is performed by the automorphism method. Determine the ‘dimension’ of the phenomena (vide infra).

The KH-map array holds values of input vectors which can be thought of as probabilities, fuzzy values or values that can be natural tied to logical/Boolean operations and values. Example of a KH-map of 6 variables is given in FIG. (5A). A general n-dimensional KH-map showing the generalized address scheme is shown in FIG. (6).

The core method (or core software engine);

(i) creates association rules directly, at various levels of approximation, via the use of the Quine-McCluskey method or an equivalent procedure

(ii) creates a multiplicative neural network for fine-tuning which is the most natural kind for representing complex phenomena

(iii) is user-modified (e.g. trained in a supervised mode) to learn to classify

(iv) creates a neural network whose weights are easily and naturally interpretable in terms of probability theory

(v) creates a neural network which is the most general version of the dimensional analysis as used in physics (Olson, R (1973) Essentials of Engineering Fluid Mechanics, Intext Educational Publishers, NY, and White, F. (1979) Fluid Mechanics, McGraw-Hill, New York).

(vi) produces a simplified two-dimensional locally-Euclidean plane approximation grid

(vii) is easily modified to create nonspherical clusters via artificial variables

(viii) performs directed datamining clustering in that all events associated with another event can be found

(ix) performs spectral analysis in the time domain to work on time series or sequential data such as DNA

(x) is an ideal data structure for representing joint probabilities or fuzzy values

### BRIEF DESCRIPTION OF THE DRAWINGS

FIG. 1: Data Flow Diagram of the Invention

FIG. 2: Logic and Option Diagram

FIG. 3: Examples of Clusters

FIG. 4: Graph Automorphism

FIG 5A: An example of a KH-map for 6 variables as a 2-D table

FIG. 5B and FIG. 5C: The corner nodes/cells in FIG. 5A

FIG. 6: Addresses (node numbers) of Cells on a KH-map

FIG. 7: Results of the First and Second Phase Approximation Methods for some 2D cases

FIG. 8A: Thresholding and Minimization. The KH-map of FIG. 8A (in this case a simple K-map, or Karnaugh map) shows the occurrences of various events

FIG. 8B: The KH-map of FIG. 8A is thresholded at 32 to produce a binary table

FIG. 9: The Boolean circuit depiction of the minimization/simplification [clustering] of FIG. 8A and FIG. 8B.

FIG. 10A: The Generalized Problem: parallel and/or serial choices. A graph-theoretic depiction of the problem of selecting a balanced diet (B).

FIG. 10B: The two-level Boolean circuit/recognizer of FIG. 10A and the general equation for B.

FIG. 10C: The complement of the blanced diet, or the unbalanced diet (\overline{B}).

FIG. 10D: Yet another two level circuit in which the form is the same as in FIG. 10B (which is for \overline{B}) but the circuit in FIG. 10D is for B. This is the kind of clustering produced by the invention.

FIG. 11: The simple two stage multiplicative network which solves the XOR problem.

FIG. 12: A simple example of generalization of FIG. 11.

FIG. 13A: A variation on a special kind of fuzzy logic.

FIG. 13B: Arbitrarily shaped clustering can be accomplished via artificial variables along the lines of the Likert scale fuzzy logic.

FIG. 14 Clusters on the Hypercube:

FIG. 15A Wrapping the KH-map on a Cylinder.

FIG. 15B Wrapping the KH-map on a Torus.

FIG. 16: Topological Ordering of the Nodes of a Hypercube on a Virtual Grid showing only some edges.

FIG. 17: The Initial Locally-Euclidean Grid Creation Process

FIG. 18: 2-D Locally-Euclidean Grid [Mesh] Creation.

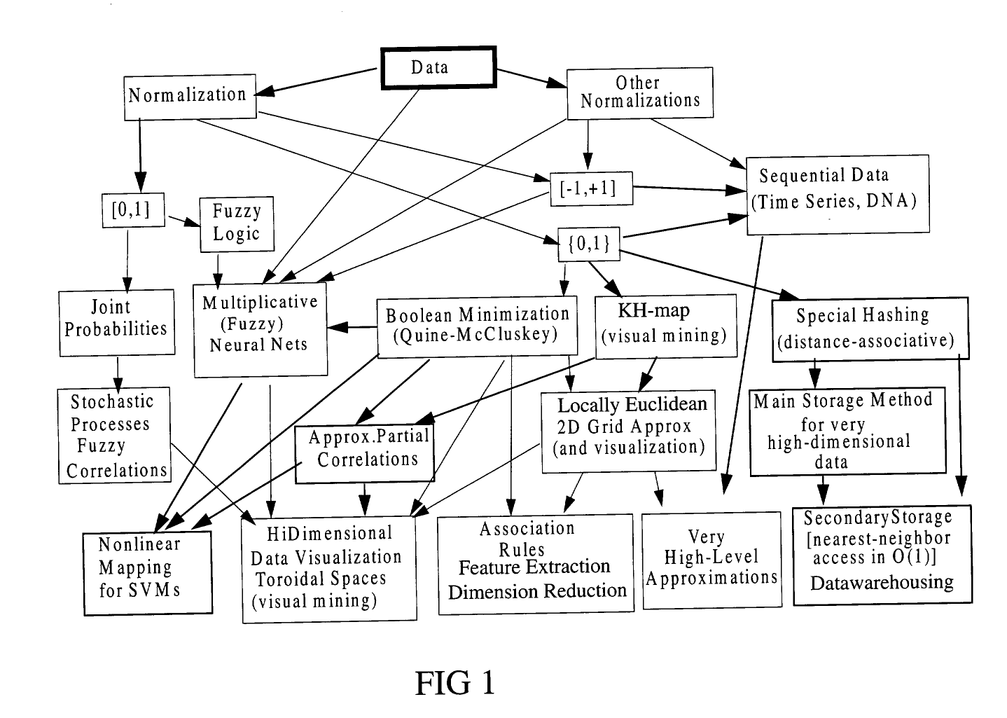

### DETAILED DESCRIPTION OF THE INVENTION

### Unsupervised Clustering via Boolean Minimization, Association Rules

The present invention that provides supervised and unsupervised clustering, datamining, classifiction and estimation, herein referrred to as HUBAN (High-Dimensional scalable, Unified-warehousing-datamining, Boolean-minimization-based, Association-Rule-Finder and Neuro-Fuzzy Networ).

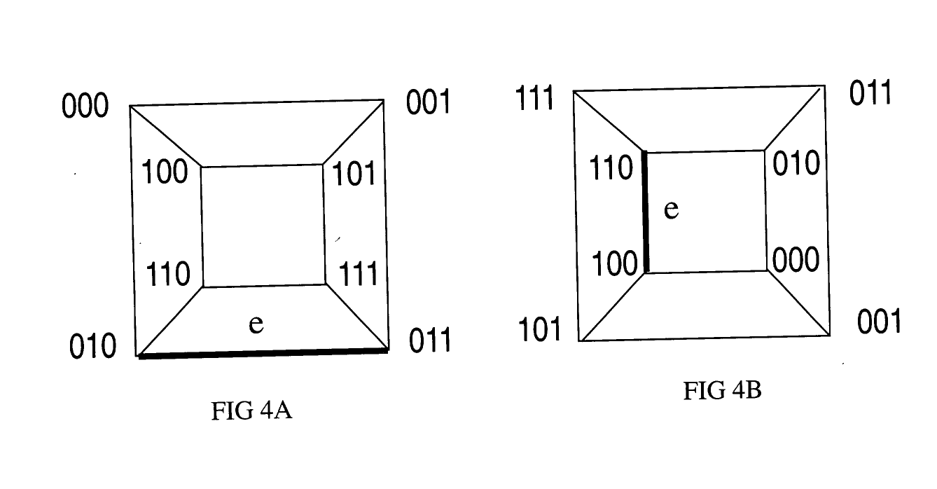

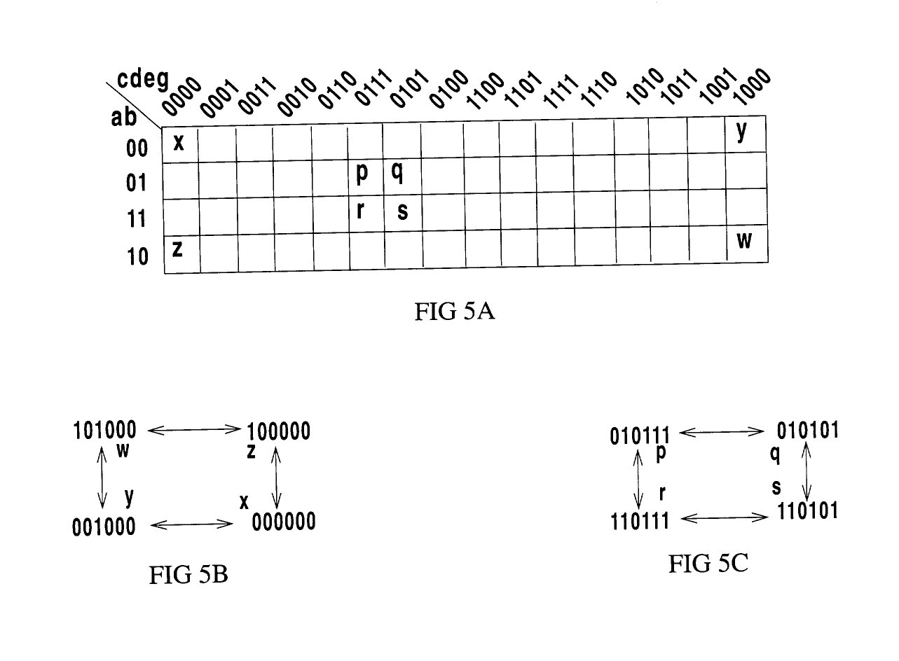

I) The method will be illustrated, without loss of generality, via examples, and is not meant to be a limitation. Normalize the set of n-dimensional input vectors { [symbol] } to {0, 1}ⁿ. In high dimensions almost all the data are in corners [Hecht-Nielsen, R (1990) Neurocomputing, Addison-Wesley, Reading, Mass.]. Therefore this approximation of accumulation of the unnormalized input vectors in the nearest nodes or the nearest corners of the n-cube is an excellent one. Some information is lost, however, the second approximation (vide infra) has the effect of undoing the the information loss effects of the first approximation. These bitstrings/vectors are the first approximation. These bitstrings are also the nodes of the n-dimensional hypercube [n-cube or nD-cube from now on]. The automorphism on an input-vector hypercube is equivalent to a permutation of the components of the input vector, and corresponds to relabeling the addresses of the cells of the KH-map. The hypercube in FIG. 4A is changed to that of FIG. 4B by a change of the variables (i.e. node numbering) and is an automorphism. By changing the ordering of the variables (e.g. permuting the bitstrings) we can create a hypercube in which most of the data can cluster in a given subspace of the problem space. The topology of the KH-map, as in FIG. (5A) is such that the corners of the map are are ‘neighbors’. e.g. have distance 1 using the Hamming metric, as are the cluster of 4 cells in the middle as in FIG. (5A) which are shown in FIG. (5B) and FIG. (5C) respectively to be “neighbors” e.g. differ by one bit. The method normalizes every component of each input vector xⱼ to the interval [0,1], that is, the mapping is given by f: [symbol] ⁿ→[0, 1]ⁿ.The function

$$2 a ) f ( x ) = \frac{[ x - {x}_{min} ]}{[ {x}_{max} - {x}_{min} ]}$$

easily accomplishes this. (It would be easier, in practice, to think of the vectors as being in the interval [0,1] as in fuzzy logic and probability theory; however, the interval [−1, 1] may also be used, especially for time series, or for correlation-related methods.) In the second step of the first phase we reduce every component of the vector via g: [0, 1]→{0, 1}. This can be done quite easily via the Heaviside Unit Step Function. The Heaviside Unit Step Function U(x) is defined as

$$2 b ) U ( x ) = \{ \begin{matrix}1 & x > 0 \\ 0 & x < 0\end{matrix}$$

Therefore for each component of every input vector, using the function

$$3 ) x = U ( x - β ) = U ( \frac{[ x - {x}_{min} ]}{[ {x}_{max} - {x}_{min} ]} - β )$$

where the bias can be set 0≦β≦1 but typically β=0.5, the method normalizes each component of the input vector to the interval [0,1]. Each bitstring/vector is also the hash address of each input vector, thus represents the hashing function. Thus we also have created a datawarehousing structure in which records can be fetched in O(1), the Holy Grail of databases, datawarehouses, and since it is also distance-based, it provides the perfect storage for the k-nearest neighbors type datamining/clustering algorithms.

II) KH-map: The KH-map is (i) a data-structure for arrays with very special properties, (ii) a visualization of the input data in a particular way, (iii) a visual dataming tool (iv) and for VLD (very large dimensional) data (which will not fit in main/primary storage) a sparse array or hash-based system that is also distance-based (which is a unique property for hashing-based access, also called associative access) for efficient access to the datawarehouse. A generalized view of the KH-map showing the addressing scheme is given in FIG. (6). The maximum Hamming distance (number of bits by which two bitstrings (vectors) differ) is approximately half the diagonal which is

$$\sqrt{{( \frac{n}{2} )}^{2} + {( \frac{m}{2} )}^{2}} .$$

Since the map is usually constructed such that m≈n this is approximately

$$\frac{( n + m )}{2} \sqrt{2} = \frac{( n + m )}{\sqrt{2}} .$$

The bitstrings are concatenations of row and column addresses of cells. The method saves the occurrence counts of the binary input vectors in the KH-map data structure. For very large dimensions hashing will be much more effective and efficient than the array structure. For smaller dimensions the array vs hash address is immaterial, since it is very easy to create a bucket-splitting algorithm to handle all sizes; however, for large dimensional data sets a special hashing technique (vide infra) in which the normalization resulting in the bitstring is used as the address so that one may use associative access coupled with the Hamming distance inherent in the system to search extremely efficiently for nearest neighbors. For visualization and explanation purposes (not to be construed as a limitation) in this invention the KH-map will be referred to as a 2D array although in reality an associative access mechanism which is distance-based can/will be used. Since it is an array, we use the symbol H(i,j) or Hᵢⱼ or H[i,j] to refer to the KH-map elements.

Additionally, the invention uses this 2D version of the hypercube as a [discrete] grid as an approximation of [symbol] ². An n-dimensional KH-map is an 2^{└n/2┘}×2^{┌n/2┐} array (where the └ ┘ denotes the floor and the ┌ ┐ stands for the ceiling function) whose cells (nodes) are numbered according to Gray-coding, and on which a distance metric has been defined. For even n, └n/2┘=┌n/2┐ and for odd n, ┌n/2┐=└n/2┘+1. The KH-map is also a 2D linear array [Leighton, T (1992) Introduction to Parallel Algorithms and Architectures, Morgan Kaufmann, San Mateo, Calif.] in the terminology of hypercubes or equivalently, a mesh [Rosen, K (1994) Discrete Mathematics and Its Applications, McGraw-Hill, NY] in the terminology of graph theory. An n-cube [n-dimensional hypercube] has n2ⁿ⁻¹ edges, however a KH-map has only 2ⁿ⁺¹ edges. These are the visible edges (of the n-cube) when only the nodes that make up the KH-map are shown. Therefore there are n2ⁿ⁻¹−2ⁿ⁺¹ edges that are not visible. The grid formed by the KH-map is only that of the visible edges. Each node on the KH-map has 4 neighbors; these are those nodes that which are connected via the visible edges. Thus for any node z, only nodes yₖ, k=1, 2, 3, 4 with [unweighted] Hamming distance dₕ(z, yₖ)=1 are visually adjacent to node z. Therefore the method creates a metric space from the KH-map so that it can be used to reduce high-dimensional data to 2D for visualization on a coarse-grained scale. The KH-map is an embedding in an n-dimensional hypercube or in vector terms. The steps in the construction of the KH-map used by the invention are;

II.i) Split the n dimensions into └n/2┘ and ┌n/2┐ for the two sides of the 2D array.

II.ii) Use the reflection method as many times as necessary to create the numbering for the cell addresses

II.iii) Connect these cells (which are really nodes of the nD hypercube) with edges so that the result is a 2D array

II.iv) Assign the weights 0<α<½ to each of these edges on the mesh. Assign the weights 1/α to all the other edges. The exact value of α will depend on n, the size of the hypercube.

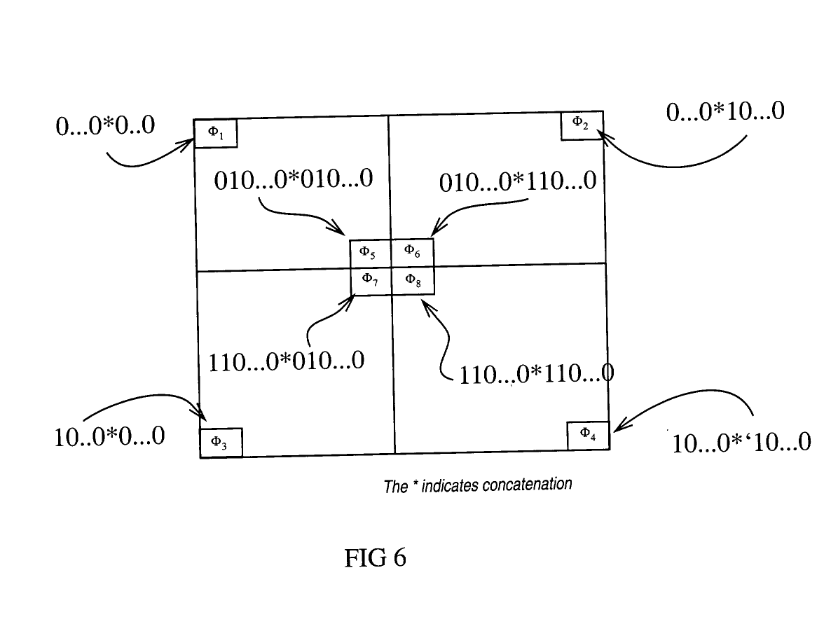

The situation can be depicted in general as shown in FIG. 6. As an example, select some node z, around the middle, and find the nodes that are adjacent to this node on the hypercube. They cannot be any further than half the diagonal distance (diameter) which is 2^{┌n/2}┐+2^{└n/2}┘≦2^{┌n/2┐}+1.

III) Cluster Formation: For each threshold Tₖ, the method creates a new KH-map. For purposes of description, as in FIG. (2), the threshold is assumed to be normalized to the interval [0,1] which is accomplished by dividing each entry in the KH-map by the highest entry (highest frequency of occurrence of the events).

Hᵢⱼ=U(Hᵢⱼ−Tₖ) 4)

The invention applies the Quine-McCluskey algorithm (or another algorithm functionally equivalent) to the data in the KH-map to minimize the Boolean function represented by the KH-map and/or the nD-hypercube, after the thresholding normalization. The resulting minimization is in DNF (disjunctive normal form) also known as SOP (sum of products) form. The resulting Boolean function in DNF/SOP form is the association rule at that threshold level. Examples of this method are shown in FIG. (7A) through FIG. (7E) for various kinds of clusters in two dimensions. The first column shows the distribution of the input vectors. The second column shows the resulting K-map (KH-map) and finally the resulting Boolean minimization is given as a DNF (or SOP) Boolean function to show that the clustering method works as explained. Specifically for each drawing:

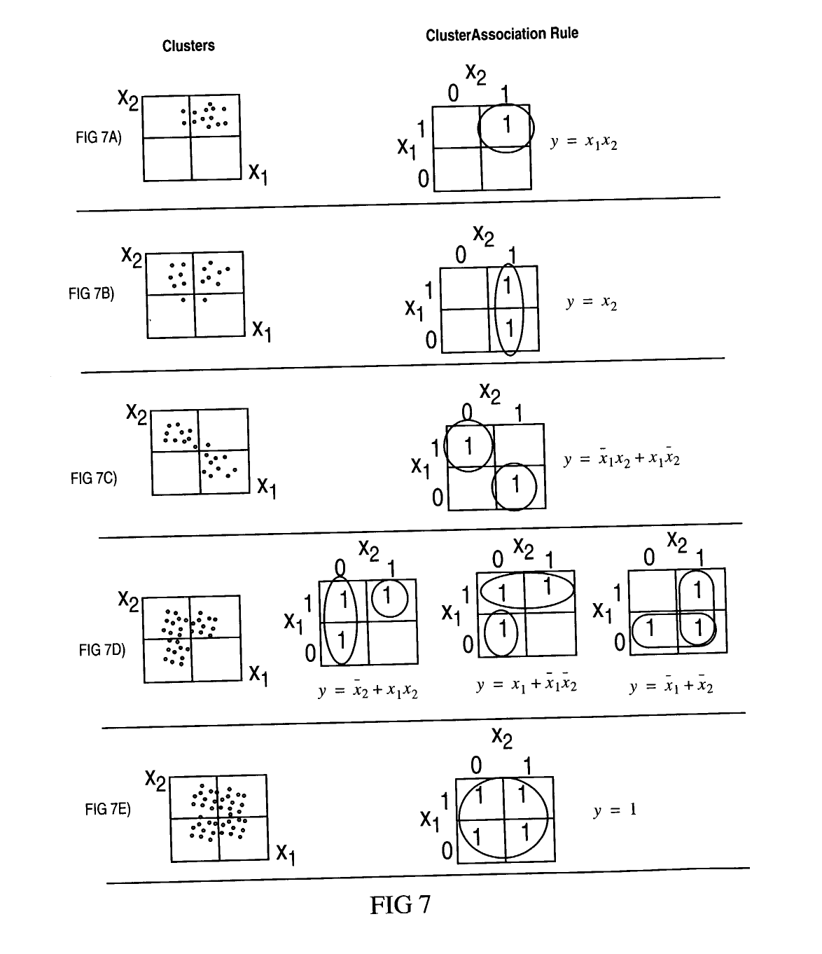

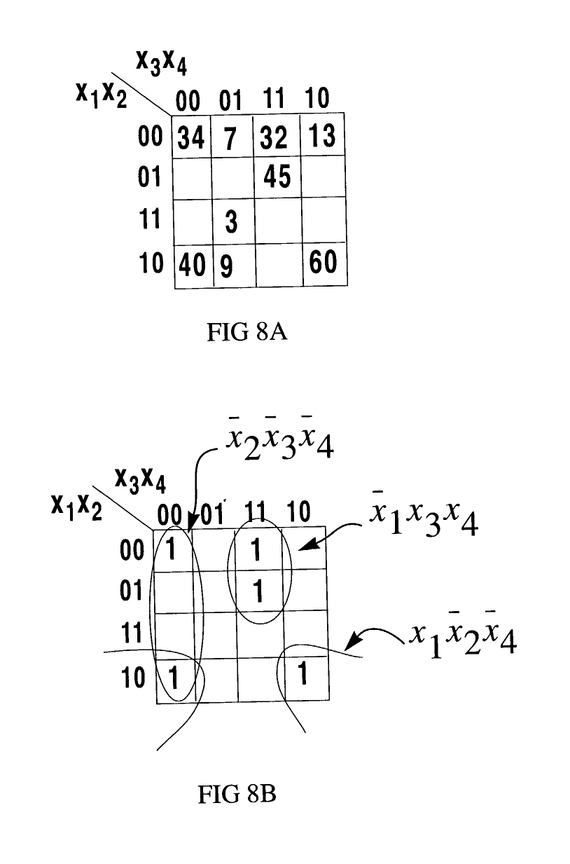

FIG. 7A) Single Quadrant Clustering: On target. There is a single cluster and it occurs at both x₁ and x₂ high.

FIG. 7B) Double Neighbor Quadrants: On target. Splits into two clusters in the first phase and they gets cobbled together in the second phase.

FIG. 7C) Clearly this little neural network neatly solves the XOR problem of the perceptron. We can choose to have a single output or two. This also applies to EQ (Equivalence) which is the complement of XOR.

FIG. 7D) Triple Quadrants: We seem to have choices here but they are all equivalent as can be verified by checking the truth tables. Several choices are available.

FIG. 7E) Uniform or Dead Center: This simplifies to y=1 which could be interpreted to mean that every input occurs approximately equally. In very high dimensions this is unlikely to occur.

As the various minimizations are performed iteratively at different thresholding levels, we get a set of association rules which can then be combined to produce the set of association rules for the data.

III.ii) When the the method is running in the unsupervised mode, then it treats each minterm is a [nonlinear] cluster and uses it as a part of the association rule at that threshold level.

III.iii) When the the method is running in the supervised mode, the user can create user-defined categories from the clusters during the training of the neural network such as nonlinearly separable clusters (such as the XOR) as shown in FIG. (7C), and FIG. (11).

III.iv) The method then determines the association rule(s) and at the same time determines the architecture of novel neural network architecture by determining the number of middle/hidden layer nodes from the number of clusters. An example of a KH-map showing clusters is given in FIG. (8A) and (8B) while corresponding neural network is given in FIG. (9). The minterms and the association rules derived from them are the nonlinearly coupled groups of variables analogous to dimensionless groups of physics and thus perform nonlinear dimension reduction of the problem/ data. The minterms are shown in FIG. (8B) for the KH-map data shown in FIG. (8A), and the min-terms are also shown for the same example in the corresponding neural network shown in FIG. (9).

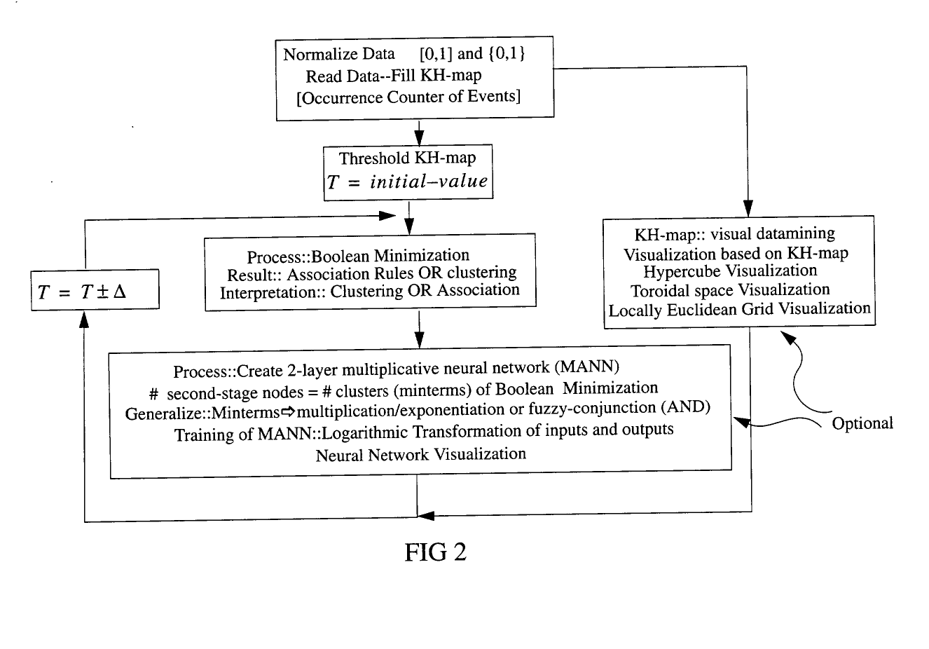

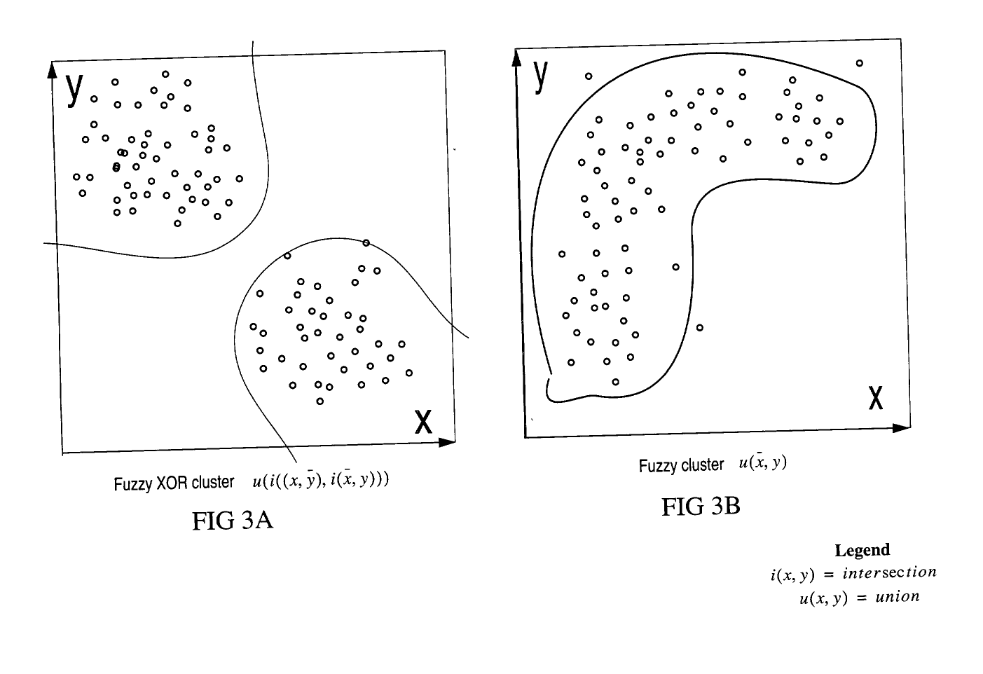

IIIvi) The method then decrements/increments the threshold (FIG. 2) and repeats as many times as desired association rules at every level of the threshold which it then combines into one big assocation rule This association rule is of form (where U(x) is the Heaviside Unit Step function:

$$5 ) {R}_{a} = {\sum }_{k}^{N} U ( {T}_{k} - S ) {\sum }_{j}^{M} {f}_{j} ( {x}^{>} , k )$$

0≦Tₖ≦1 is the threshold at the kth level, 0≦S≦1 is the significance level, and the fⱼ( [symbol] , k) are the minterms at the kth threshold level. This kind of particular fuzzy-operation was first disclosed by Hubey in (“Fuzzy Operators”, Proceedings of the 4th World Multiconference on Systems, Cybernetics, and Informatics (SCI2000), Jul. 23-26, 2000, Orlando, Fla.).

IV) The method then creates a novel neural network which is a multiplicative neural network classifier/categorizer that performs nonlinear separation of inputs while reducing the dimensionality of the problem, and which can be implemented in hardware for specific kinds of classification and estimation tasks. The method allows the user to create the number of categories that the method should recognize by inputting the categories at the third (output) stage.

V) The method will renormalize (if necessary e.g. for the specific type of fuzzy logic that is in use). The earliest disclosure of the special types of fuzzy logics was in Hubey, The Diagonal Infinity, World Scientific, Singapore, 1999. Other types of fuzzy logics and neural networks were disclosed by Hubey (“Feature Selection for SVMs via Boolean Minimization”, paper #436, submitted on Feb. 22, 2002 to KDD2002 International Conference to be held in Alberta, Canada, July 23 through Jul. 26, 2002), and further disclosed in Hubey (“Arithmetic as Fuzzy Logic, Datamining and SVMs”, paper #1637, submitted on May 29, 2002 to the 2002 International Conference on Fuzzy Systems and Knowledge Discovery, Singapore, Nov. 18-22, 2002).

This invention does not find small clusters and then look for intersections of such clusters as done by Agrawal [U.S. Pat. No. 6,003,029]. This invention does not require the user to input the parameter k, as done in partitioning methods, so that it is unsupervised clustering. However the graining (from coarse to fine) can be set by the user in various ways such as creation of artificial variables to increase fine-graining of the method. The invention can be automated to iterate to find optimum graining and can produce associations and relationships at various levels of approximation and graining. This invention does not have the weakness of Hierarchical methods in that no splits or mergers are needed to be undone. The invention is not restricted to hyper-spheroidal clusters, and does not have the inability of the perceptron in recognizing XOR. The XOR problem can be solved directly in a single-layer multiplicative artificial neural network as shown in this invention. In this invention no parameters are input by the user for the [unsupervised] clustering as done in density based methods. There is no disadvantage again, as in density based methods that the crucial parameters must be input by the user. The method of this invention also has a very compact mathematical description of arbitrarily shaped clusters as in density-based methods such as DENCLUE.

This invention also uses a grid-based method but only for visualization of data. The dimensional analysis used in fluid dynamics and heat transfer analogically is a prototype of the model-based datamining methods. This invention performs something like dimensional analysis in that it creates products of variables among which empirical relationships may be sought. (Olson, R (1973) Essentials of Engineering Fluid Mechanics, Intext Educational Publishers, NY, and White, F. (1979) Fluid Mechanics, McGraw-Hill, New York). In addition, one particular kind of relationships amongst the variables is naturally tied to the method, that of Boolean Algebra, from which logical and fuzzy association rules are easily derived.

The method can then use the exponents of the variables in the nonlinear groups of variables (fuzzy minterms?) can be used as the nonlinear mapping for an SVM (Support Vector Machine) feature space.

The method will look for the occurrence of given events that specifically correlate with a given state variable by using only the data in which the variable had the “on” value. This is equivalent to determining the occurrence or nonoccurrence of events that are correlated with the occurrence of some other event, say the kth component of the input vector x^{k}.

The method can be employed/installed to run in parallel and in distributed fashion, using multiprocessing computers or in computer clusters. The methoc can divide it up the KH-map among n computers/processors, construct separate KH maps and then add the results to create one large KHmap. Or the method can use the same input data and analyze correlations among many variables on separate processors or computers.

The method increases the resolving power of the clustering by creating ‘artificial variables’ to cover the same interval as the original. An example is to use a Likert-scale fuzzy logic to divide up a typical interval into 5 intervals, as shown in FIG. (13A) and (13B). The new artificial variables for xⱼ are named {xⱼ⁻²,xⱼ⁻¹, xⱼ⁰, xⱼ¹, xⱼ²} as shown in FIG. (13B).

The method performs the equivalent of spectral domain analysis in the time-domain with the added benefit of being able to look for specific occurrences that can be expressed with logical semantics. In order to accomplish it creates successively, KHmaps of size n=m, m+1, m+2, where For example if there is a particular bitstring 101 . . . 1010 of length n that repeats, obviously in the KHmap of size n there will be a very high spike, and thus the method handles the time series and DNA sequences the same way it handles other types of data and finds clusters (periodicities). Finally, the use of the KH-map for clustering is illustrated via a simple example. Suppose the data from some datamining project yielded the KH-map as given in FIG. (8A). The grouping/clustering gives the result in FIG. (8B).

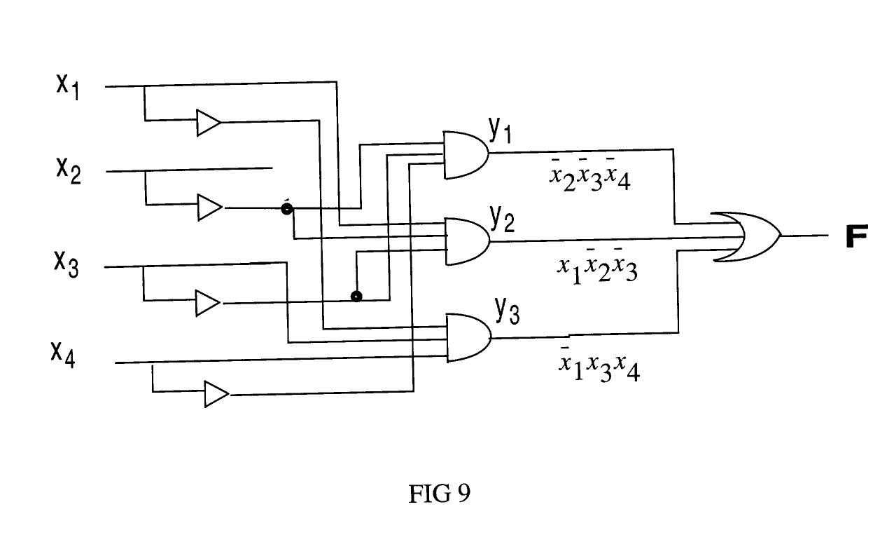

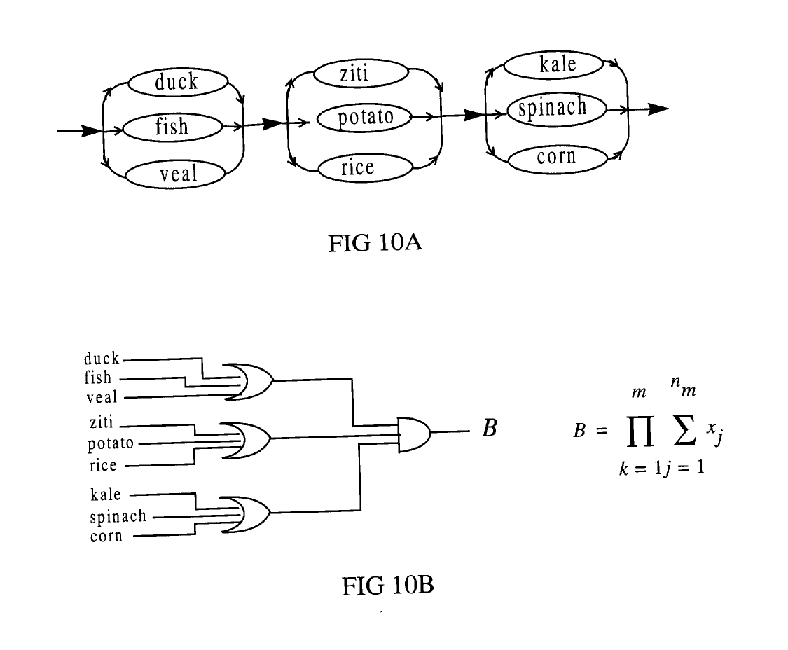

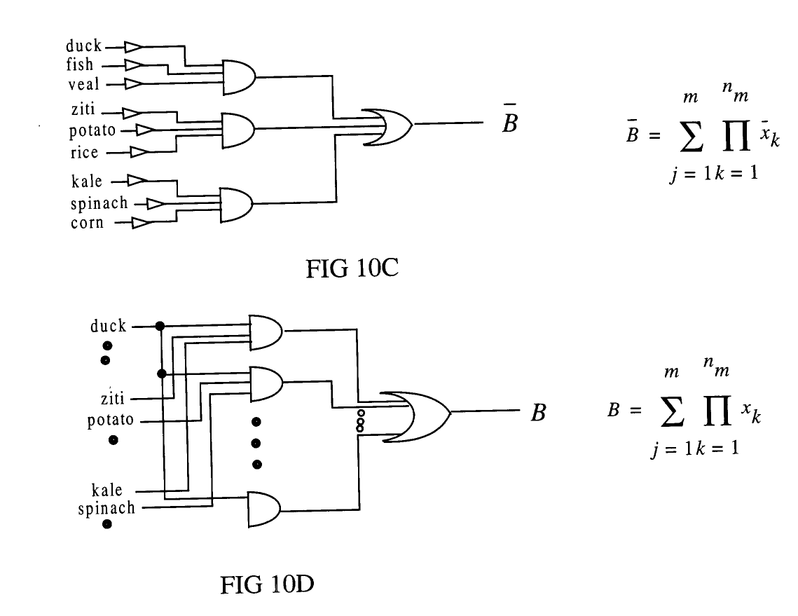

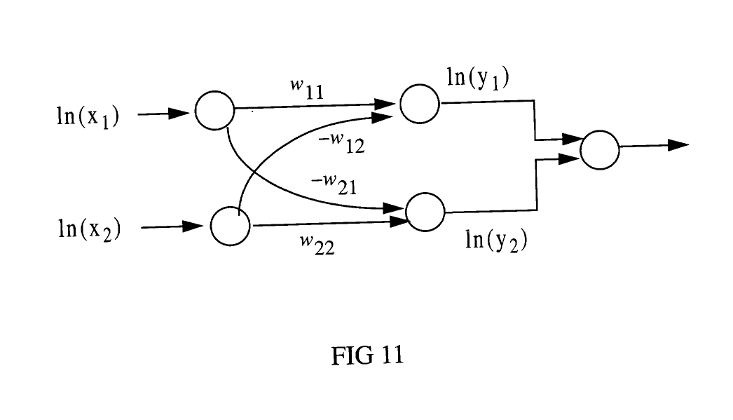

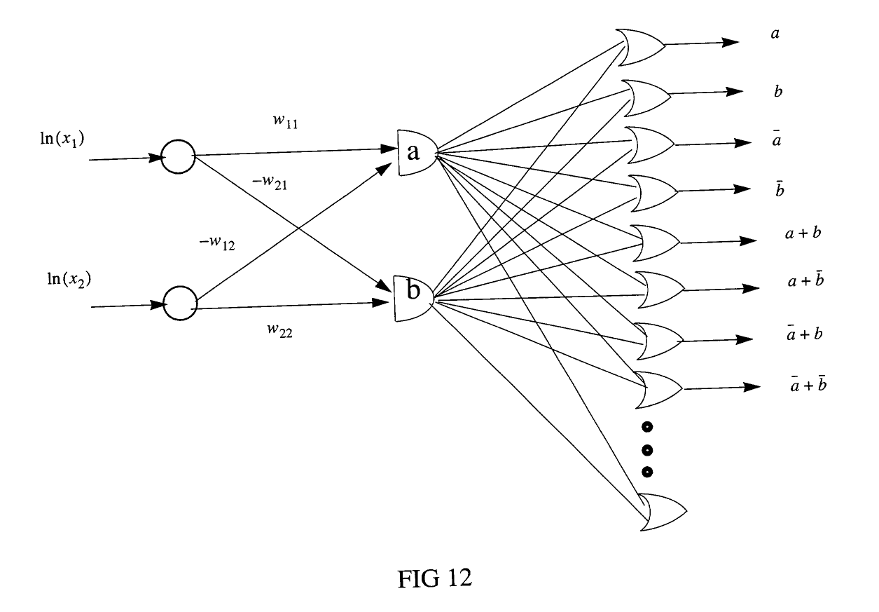

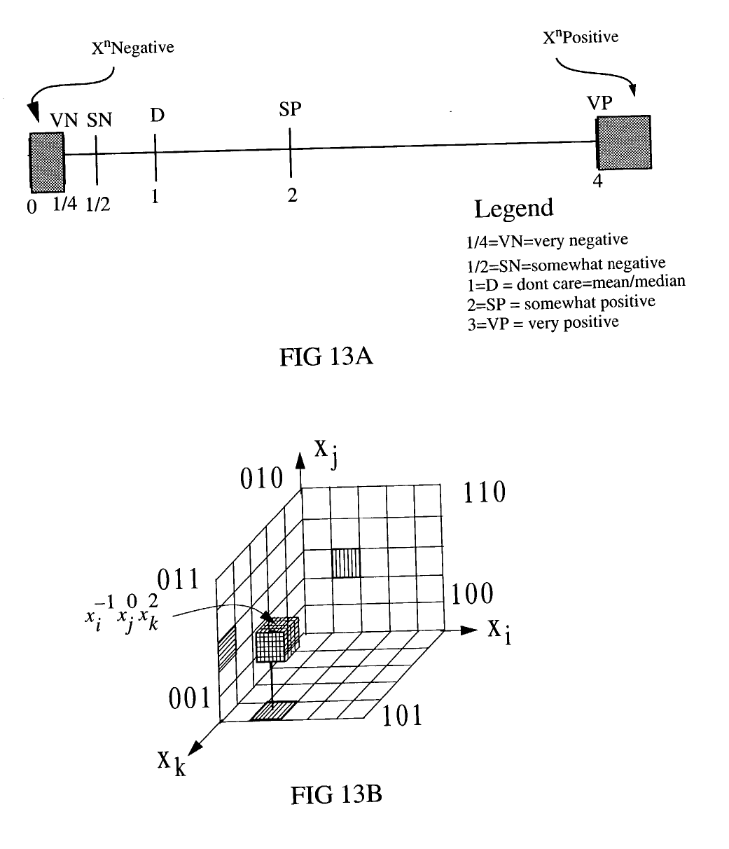

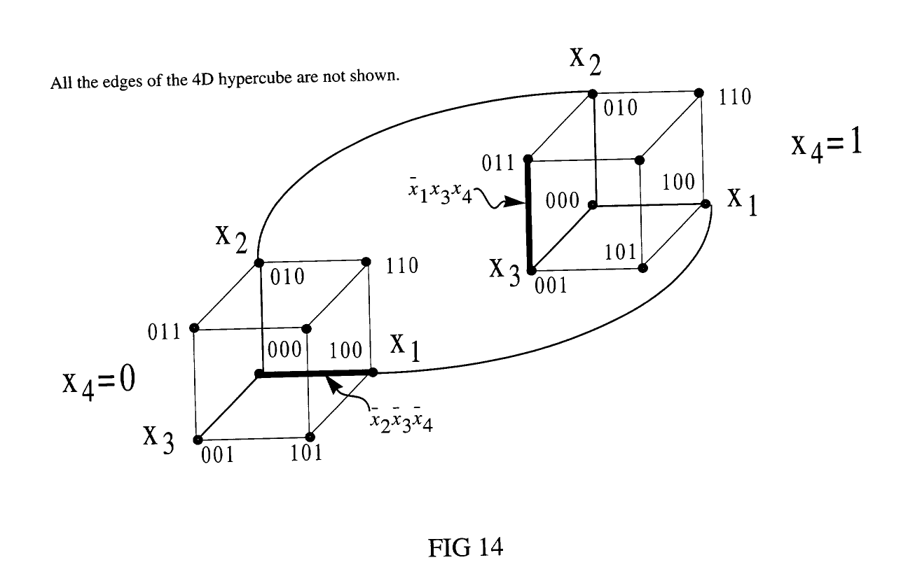

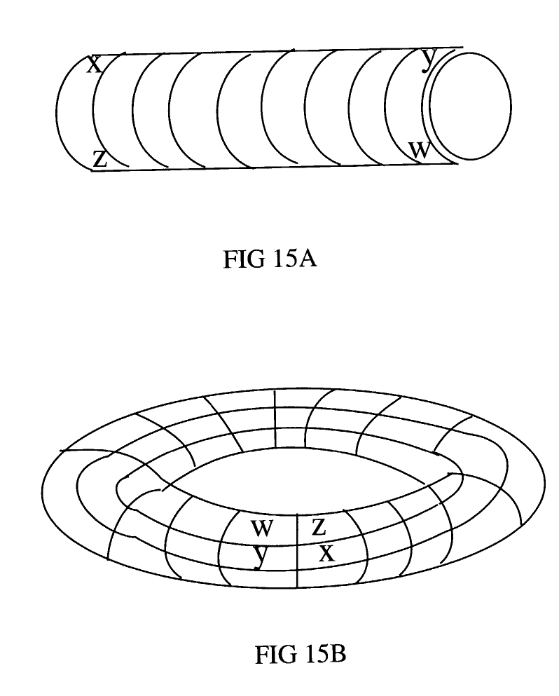

The simplification of the K-map results in the neural network, logic circuit of of FIG. 9 which is described by the Boolean function

$$6 ) F = {\overline{x}}_{2} {\overline{x}}_{3} {\overline{x}}_{4} + {x}_{1} {\overline{x}}_{2} {\overline{x}}_{3} + {\overline{x}}_{1} {x}_{3} {x}_{4}$$

one minterm for each group/cluster. Each minterm in Eq (6) represents a hyperplane (or edge on the binary) hypercube. This equation is the set of association rules for this problem. The neural-fuzzy network for this example is shown in FIG. (9). This is nothing more than a simple version of a more general problem which is illustrated in FIG. (10A) in which one is to create ‘clusters’ of food items which constitute a ‘balanced diet ’ denoted by B. The series-parallel circuit in FIG. (10A) is the representation of logical choices. It would be represented by the neural network in FIG. (10B). However, its complement (bad diet, denoted by \overline{B}) is given by the complement of the Boolean representation which is given in FIG. (10C) which is in the DNF (SOP) form. However, what the method does is represented in FIG. (10D) in which the method takes as inputs the various foods, then creates multiplicative clusters, and then categorizes them in the last stage of the neural network. In the preferred emobodiment, the network would go through supervised training in which it would be ‘told’ which combinations are ‘balanced diets’.

In summary, the KH-map is (i) a visualization tool, and (ii) another level of approximation (beyond the Boolean minimization/clustering). The latter, is especially important since ultimately the result is a clustering in 2D (resembling a grid, albeit with a different distance metric). Since the KH-map is a very high-level, coarse-grained clustering tool, we should order the variables in the input vectors so that (i) the greatest clusters (the most important) ones should occur somewhere near the middle of the map, and (ii) the clusters themselves occur near each other. This form may be called the canonical form of the KH-map.

Multiplicative Neural Network Creation, Fuzzy-Logical Interpreation, Training-FineTuning the Neural Network, Supervised Categorization, Estimation,

There are two ways the results of the foregoing can be interpreted. Eq. (6) can be interpreted as the result of an unsupervised clustering/datamining method that is the top-level clustering of data and hence the association rule(s) of the data. A second interpretation (which is much more powerful) can be obtained by re-interpreting the circuit if FIG. 9, and Eq (6) differently); it is written as

$$7 ) [ \begin{matrix}{y}_{1} \\ {y}_{2} \\ {y}_{3}\end{matrix} ] = [ \begin{matrix}{\overline{x}}_{2} {\overline{x}}_{3} {\overline{x}}_{4} \\ {x}_{1} {\overline{x}}_{2} {\overline{x}}_{3} \\ {\overline{x}}_{1} {x}_{3} {x}_{4}\end{matrix} ]$$

The axioms of fuzzy logic can be found in many books (for example Klir, G. and B. Yuan (1995) Fuzzy Sets and Fuzzy Logic, Prentice-Hall, Englewood Cliffs, N.J.). Also in Hubey [The Diagonal Infinity, World Scientific, Singapore, 1999] is the special logic that is useful for training of arithmetic (interval-scaled or ratio-scaled) multiplicative neural networks. Since we can interpret multiplication as akin to a logical-AND (conjunction) and addition as a logical-OR (disjunction), we can then convert Eq (7) to the logical-form of a neural network and train it using the actual data values instead of the normalized values. In Eq (7) the overbars represent Boolean complements. By using the specialized fuzzy logics disclosed partially first in Hubey (The Diagonal Infinity, World Scientific, Singapore, 1999) and further expanded in Hubey (“Feature Selection for SVMs via Boolean Minimization”, paper #436, submitted on Feb. 22, 2002 to KDD2002 International Conference to be held in Alberta, Canada, July 23 through Jul. 26, 2002), and further disclosed in Hubey (“Arithmetic as Fuzzy Logic, Datamining and SVMs”, paper #1637, submitted on May 29, 2002 to the 2002 International Conference on Fuzzy Systems and Knowledge Discovery, to be held in Singapore, Nov. 18-22, 2002) using C(x)=1/x as the complement and using these fuzzy logics one can treat the Boolean clusters shown as minterms in Eq. (6) and Ea (7) in ways similar to dimensionless groups in physics and fluid dynamics, then generalizing the clusters (minterms) to algebraic forms as powers as shown in Eq (8).

The method uses the rewriting of the equation as

$$8 ) [ \begin{matrix}{y}_{1} \\ {y}_{2} \\ {y}_{3}\end{matrix} ] = [ \begin{matrix}{x}_{2}^{- {w}_{12}} {x}_{3}^{- {w}_{13}} {x}_{4}^{- {w}_{14}} \\ {x}_{1}^{{w}_{21}} {x}_{2}^{- {w}_{22}} {x}_{3}^{- {w}_{23}} \\ {x}_{1}^{- {w}_{31}} {x}_{3}^{{w}_{33}} {x}_{4}^{{w}_{34}}\end{matrix} ] = [ \begin{matrix}\frac{1}{{x}_{2}^{{w}_{12}} {x}_{3}^{{w}_{13}} {x}_{4}^{{w}_{14}}} \\ \frac{{x}_{1}^{{w}_{21}}}{{x}_{2}^{{w}_{22}} {x}_{3}^{{w}_{23}}} \\ \frac{{x}_{3}^{{w}_{33}} {x}_{4}^{{w}_{34}}}{{x}_{1}^{{w}_{31}}}\end{matrix} ]$$

and treats the products as arithmetic products (not Boolean products) and the weights wᵢⱼ as arithmetic exponents of the inputs xⱼ. It should be noted that some of the weights are negative. Using the fuzzy-logic above, the method interprets the the negative weights as complements or negations. Therefore the method interprets for the user the output variable y₃ as co-varying with input variables x₃ and x₄ (increasing and decreasing in the same direction) but contra-varying with x₁ (moving in opposite directions).

Furthermore, the invention treats groups, x₂^{-w}^{₁₂}x₃^{-w}^{₁₃}x₄^{-w}^{₁₄}, x₁^{w}^{₂₁}x₂^{-w}^{₂₂}x₃^{-w}^{₂₃}, and x₁^{-w}^{₃₁}x₃^{w}^{₃₃}x₄^{w}^{₃₄} asserving functions similar to dimensionless groups of fluid dynamics. Hence, the method achieves nonlinear dimension reduction in contrast to PCA (Principal Component Analysis) which is a linear method.

As a simple example, a simple single-layer network that solves the XOR problem of Minsky is shown in FIG. (11).The equations for the XOR problem are

ln(y₁)=w₁₁ln(x₁)−w₁₂ln(x₂)=ln(x₁^{w}^{₁₁})+ln(x₂^{w}^{₂₂}) 9)

ln(y₂)=−w₂₁ln(x₁)+w₂₂ln(x₂)=ln(x₁^{-w}^{₂₁})+ln(x₂^{w}^{₂₂}) 10)

which can also be written as y₁=x₁^{w}^{₁₁}·x₂^{-w}^{₁₂} and y₂=x₁^{-w}^{₂₁}·x₂^{w}^{₂₂}. Clearly, here we interpret the negative powers as ‘negative correlation’ or as ‘fuzzy complement’ since

ln(\overline{x})=ln(1/x)=ln(x⁻¹)=−ln(x)

The overbar on the x on the lhs is a Boolean complement. Using the complementation 1/x (as disclosed first by Hubey, The Diagonal Infinity, World Scientific, Singapore, 1999), it can be represented as ln(1/x) or ln(x⁻¹) which is −ln(x). Since the logarithm of zero is negative infinity, the method uses fuzzy logics disclosed by Hubey in (Hubey, H. M. “Feature Selection for SVMs via Boolean Minimization”, paper #436, submitted on Feb. 22, 2002 to KDD2002 International Conference to be held in Alberta, Canada, July 23 through Jul. 26, 2002), and further disclosed in (Hubey, H. M., “Arithmetic as Fuzzy Logic, Datamining and SVMs”, paper #1637, submitted on May 29, 2002 to the 2002 International Conference on Fuzzy Systems and Knowledge Discovery, to be held in Singapore, Nov. 18-22, 2002).

In general the outputs (using the suppressed summation notation of Einstein) for this ANN are of the type

$$13 ) ln ( {y}_{i} ) = {w}_{i k} ln ( {x}_{k} ) o r {y}_{i} = {\prod }_{k = 1}^{n} {x}_{k}^{{w}_{i k}}$$

where the repeated index denotes summation over that index. This network is obviously a [non-linear] polynomial network, and thus does not have to “approximate” polynomial functions as the standard neural networks. The clustering is naturally explicable in terms of logic so that association rules follow easily. However, there is also embedded in this method, a visualization that resembles some aspects of the grid-based methods and is intuitively easily comprehensible.

KH-Visualization, Toroidal Visualization, Visual-Datamining, and Locally Euclidean Grid

The method reduces the hypercube to 2D or 3D for visualization purposes. In 2D the visualization is done via the KH-map, or the toroidal map (FIG. (15A) and FIG. (15B)). This method of wrapping the KH-map onto a torus was first shown in (Hubey, H. M. (1994) Mathematical and Computational Linguistics, Mir Domu Tvoemu, Moscow, Russia) and then again later in (Hubey, H. M. (1999) The Diagonal Infinity: problems of multiple scales, World Scientific, Singapore.) There is an intimate link between hypercubes, bitstrings, and KH-maps. The n-dimensional 1L hypercube has N=2ⁿ nodes and n2 ⁿ⁻¹ edges. Each node corresponds to an n-bit binary string, and two nodes are linked with an edge if and only if their binary strings differ in precisely one bit. Each node is incident to n=lg(N) [where lg(x)=log2(x)] other nodes, one for each bit position. An edge is called a dimension-k edge if it links two nodes that differ in the kth bit position. The notation u^{k} is used to denote a neighbor of u across dimension k in the hypercube [Leighton, T (1992) Introduction to Parallel Algorithms and Architectures, Morgan Kaufmann, San Mateo, Calif.]. Given any string u=u₁ . . . u_{lgN}, the string u^{k} is the same as u except that the kth bit is complemented. The string u may be treated as a vector (or a tensor of rank 1). Using d(u, v) the Hamming distance ∀u∀k[d(u, u^{k})=1]. The hypercube is node and edge symmetric; by just relabelling the nodes, we can map any node onto any other node, and any edge onto any other edge. Examples can be seen in Leighton[Leighton, T (1992) Introduction to Parallel Algorithms and Architectures, Morgan Kaufmann, San Mateo, Calif.]. Any nD (n-dimensional) data can be thought of as a series of (n−1)D hypercubes. This process can be used iteratively to reduce high-dimensional spaces to visualizable 2D or 3D slices. Properties of high-dimensional hypercubes are not intuitively straightforward. Most of the data in high dimensional spaces exists in the corners since a hypercube is like a porcupine [Hecht-Nielsen, R (1990) Neurocomputing, Addison-Wesley, Reading, Mass.].

For n-cube, only 4 nodes can be distance-1 on the KH-map from any node. Only 8 can be distance-2, and so on. Meanwhile, on the hypercube, the maximum distance is n. The Gray-code distributes the nodes of the n-cube so that they can be treated somewhat like the nodes of a discretization of the Euclidean plane, albeit with a different distance metric. If the components of the input vector were to be rearranged so that the distances on the 2D KHmap were to correlate with the dissimilarities amongst the various occurrences of the inputs i.e. the Hᵢⱼ, then for large dimensional problems the grid represented by the KHmap would be a good approximation of the 2D plane upon which the phenomena would be represented. The cost function for the method to be used in permutation the components of the input vectors is easier to understand if the Hᵢⱼ are initialized to [−1,+1]. Now if the bitstrings were permuted so that large values were next to (or close to) large values (i.e. in [0,1]) and small values were next to (or near) small values (i.e. in [−1,0]) then the cost function given by

$$14 ) C ( μ , v ) = - ( {\sum }_{j = 1}^{⌊ n / 2 ⌋} {H}_{ij} \cdot {H}_{ij + μ} ) \cdot ( {\sum }_{i = 1}^{⌈ n / 2 ⌉} {H}_{ij} \cdot {H}_{i + v , j} )$$

can be used in the minimization. If small numbers are adjacent to small numbers then the products of the form Hᵢⱼ·Hᵢⱼ₊₁ are positive. Obviously for positive numbers the same holds. On the other hand if positive and negative numbers are randomly placed next to each other some of the products will cancel with others and will result in a larger C(μ, ν). An extreme case of this would if uniformly distributed random numbers populate Hᵢⱼ in which case C(μ, ν)≈0. The simplest procedure is to minimize the simplest version of Eq (14) which is

$$15 ) C ( 1 , 1 ) = - ( {\sum }_{j = 1}^{⌊ n / 2 ⌋} {H}_{ij} \cdot {H}_{ij + 1} ) \cdot ( {\sum }_{i = 1}^{⌈ n / 2 ⌉} {H}_{ij} \cdot {H}_{i + 1 , j} )$$

The invention uses Eq. (15) as the cost function for creating the locally-Euclidean grid for visualization, datamining, and generation of association functions for very high-dimensional spaces.

It is known that many techniques such as genetic methods, simulated annealing do not guarantee optimum results, but in many cases, “good-enough” heuristic results are used. A verbal description of a simple process to create such a “good-enough” initial permutation of the components of the input vector which may then be improved via evolutionary or memetic techniques such as genetic methods or simulated annealing is probably best understood in terms of the hypercube graph in a ring formation as can be seen in FIG. (16). The top-down explanation of the algorithm follows:

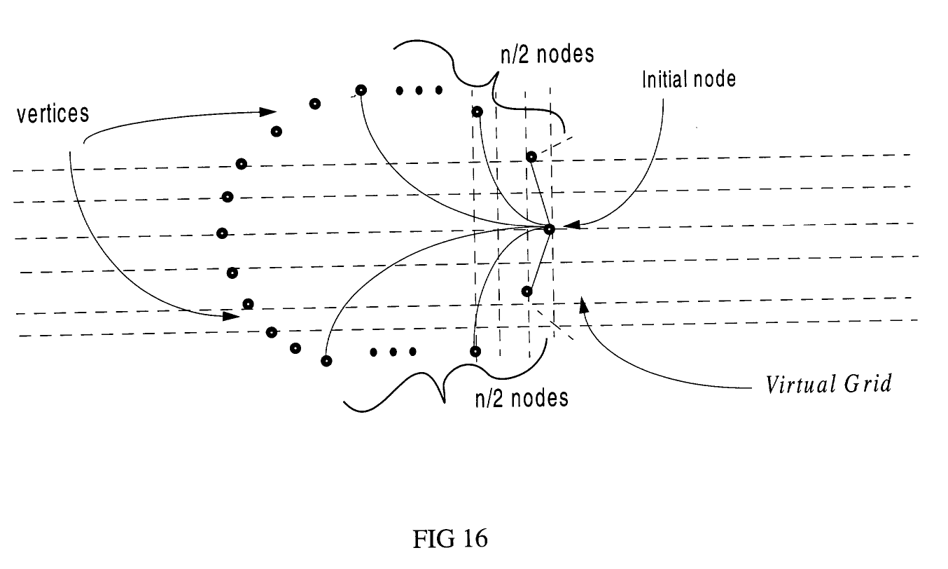

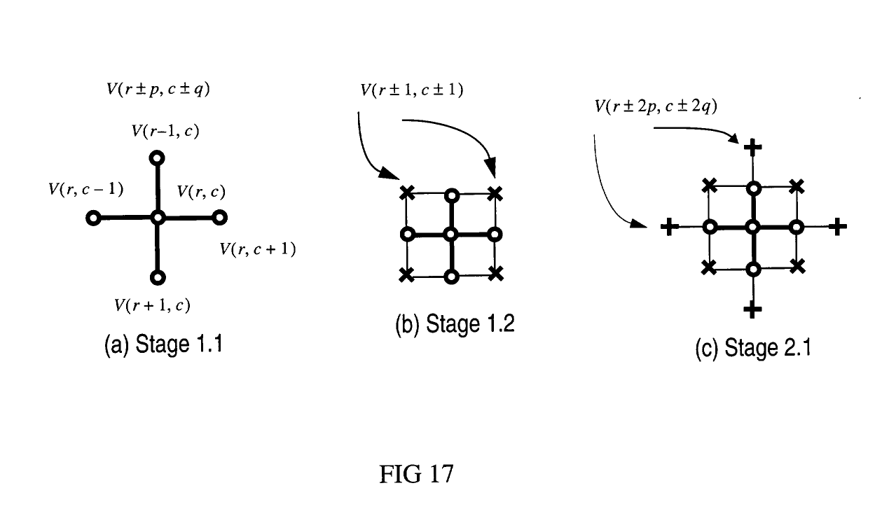

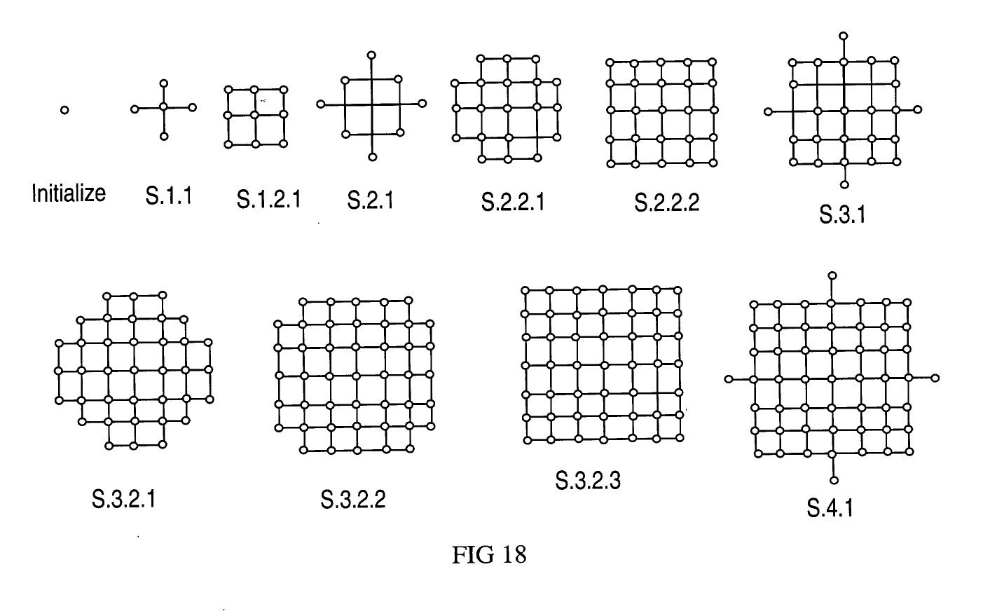

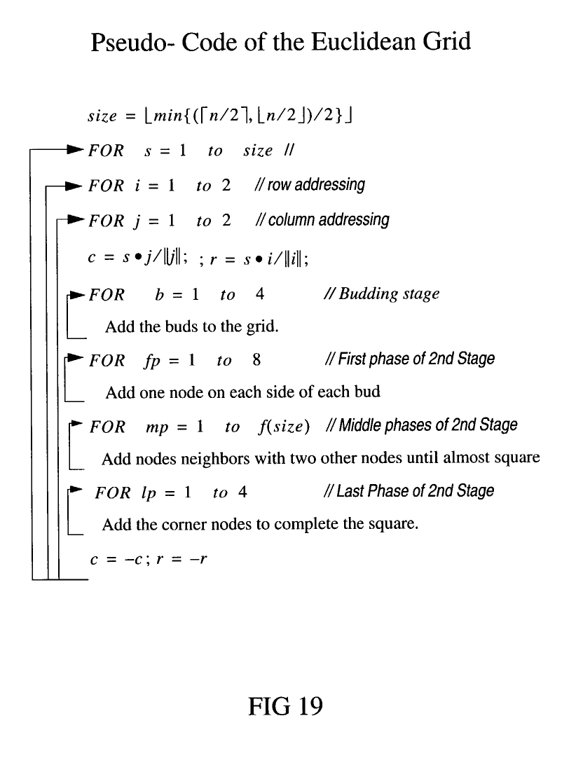

The method starts by placing set of vertices νᵢεVᵢⱼ [where V is the set of node-addresses] on a virtual grid (FIG. 16). It then uses a “greedy algorithm” to prune some edges from the hypercube so that the remaining graph is a mesh. The details were disclosed by Hubey in (“The Curse of Dimensionality, submitted to the Journal of Knowledge Discovery and Datamining, June 2000). The algorithm is illustrated in FIG. (17) and FIG. (18). The procedure is as follows consists of two stages; (i) square completion and (ii) budding stage. The buds consist of adding nodes that are neighbors of central outer nodes [S.1.1, S.2.1, S.3.1 and S.4.1 in FIG. (18)]. This always results in the addition of 4 nodes to the grid. The square completion stage itself consists of 3 phases. The first phase always consists of adding 8 nodes (one on each side of the buds [S.1.2.1, S.2.2.1, and S.3.2.1 in FIG. (18)]. The last phase consists of adding 4 nodes to create a complete square [S.2.2.2, and S.3.2.3]. The middle phase(s) of the 2nd stage are dependent on the size of the grid. Because of this some of the phases are merged into one in FIG. (18). A pseudo-code of the method is shown in FIG. (19).

What is claimed is:

1. A method for finding clusters in high-dimensional data stored in a database or datawarehouse, the method comprising the steps of:
normalizing every component of each n-dimensional input vector to the interval between zero and one;
reducing the components of the normalized input vectors to zero and one, resulting in a set of binary vectors (bit-strings) that correspond to the original input vectors;
assigning the bit-string address of each binary vector to a corresponding node in an n-dimensional hypercube;
summing the number of occurences of binary vectors at each node in the n-dimensional hypercube;
converting the sum of occurences at each node to zero and one based upon whether the sum is above or below a threshold value.

2. The method according to claim 1, wherein said dimensionality of the set of input vectors may be increased or decreased by the user.

3. The method according to claim 1, wherein said threshold value used in converting the sum of occurences of binary vectors to zero and one is provided by the user.

4. The method according to claim 1, further comprising the steps of:
incrementing or decrementing the threshold value;
reiteratively or recursively finding clusters for each threshold value;
deriving a set of sum of product form association rules for each threshold value through Boolean minimization.

5. The method according to claim 4, wherein said Boolean minimization is accomplished via the Quine-McClusky method or another equivalent method.

6. The method according to claim 1, wherein said n-dimensional hypercube is represented by a KH map data structure.

7. The method according to claim 6, wherin said KH-map is constructed by thhe following steps:
dividing the n-dimensional object space into a two dimensional array with sizes of floor(n/2) (i.e. └n/2┘ and ceiling(n/2) (i.e. ┌n/2┐ respectively;
numbering the cell addresses in the respective array by using a reflection algorithm;
connecting the edges of the cells;
assigning weights to each of the edges in the resulting mesh.

8. The method according to claim 4, further comprising the steps of:
creating a “Multiplicative” Artificial Neural Network (MANN) with the number of nodes in the hidden layer determined by the number of data custers;
performing nonlinear separation of data inputs with said MANN;
creating a comprehensible neural network through a logarithmic transformation of first layer inputs;
training said neural networks with real data values;
applying said neural networks to new data sets as a fuzzy logic decoding device;

9. The method according to claim 8, wherein said training step is based upon weights that are determined using “fuzzy” logic.

10. The method accoring to claim 6, wherein said KH-map may be permuted with a “greedy” algorithm that prunes the edges of said hypercube.

11. The method according to claim 10 wherein said greedy algorithm proceeds according to the following steps:
initializing a center node;
growing buds out from the central node;
adding one node on each side of each bud;
repeating the growing and budding steps until an appropriate sized square is formed.
